(19) United States
(12) Patent Application Publication
(10) Pub. No.: US 2020/0028177 A1
(43) Pub. Date: Jan. 23, 2020

(54) LITHIUM SECONDARY BATTERY CATHODE AND LITHIUM SECONDARY BATTERY INCLUDING SAME

(71) Applicant: Samsung SDI Co., Ltd., Yongin-si, Gyeonggi-do (KR)

(72) Inventors: Yongseok KIM, Yongin-si (KR); Jaemyung KIM, Yongin-si (KR); Sora LEE, Yongin-si (KR); Byungjoo CHUNG, Yongin-si (KR); Doyoung PARK, Yongin-si (KR); Yeonhee YOON, Yongin-si (KR)

(21) Appl. No.: 16/335,659

(22) PCT Filed: Sep. 29, 2017
(86) PCT No.: PCT/KR2017/001102

§ 371 Date: Mar. 21, 2019

(30) Foreign Application Priority Data
Oct. 10, 2016 (KR) 10-2016-0130794

(51) Int. Cl. H01M 4/62; H01M 10/0525; H01M 4/36

(52) U.S. Cl. CPC H01M 4/625; H01M 2004/028; H01M 4/362; H01M 10/0525

(57) ABSTRACT

The present invention relates to a lithium secondary battery cathode and a lithium secondary battery including the same, the lithium secondary battery cathode comprising: a current collector and a cathode active material layer, which is formed on the current collector and comprises a cathode active material, a binder, graphene, and carbon black wherein a mixture density is greater than or equal to 4.3 g/cc.

### TECHNICAL FIELD

A lithium secondary battery cathode and a lithium secondary battery including the same are disclosed.

### BACKGROUND ART

A lithium secondary battery has recently drawn attention as a power source for small portable electronic devices.

Such a lithium secondary battery includes a cathode including a cathode active material, an anode including an anode active material, a separator disposed between the cathode and the anode, and an electrolyte.

The cathode active material may include an oxide including lithium and a transition metal and having a structure capable of intercalating lithium ions such as LiCoO₂, LiMn₂O₄, LiNi₁₋ₓCoₓO₂ (0<x<1), and the like.

The anode active material may include various carbon-based materials capable of intercalating/deintercalating lithium such as artificial graphite, natural graphite, hard carbon, and the like, or a Si-based active material.

### DETAILED DESCRIPTION OF THE INVENTION

### Technical Problem

An embodiment of the present invention provides a lithium secondary battery cathode having improved cycle-life characteristics, rate capability, capacity, and stability.

### Technical Solution

Another embodiment provides a lithium secondary battery including the cathode.

An embodiment of the present invention provides a lithium secondary battery cathode including a current collector and a cathode active material layer disposed on the current collector and including a cathode active material, a binder, graphene, and carbon black wherein a material mix density is greater than or equal to 4.3 g/cc.

An amount of the graphene may be 0.01 wt % to 0.29 wt % based on 100 wt % of the cathode active material layer.

An amount of the carbon black may be 1 wt % to 3 wt % based on 100 wt % of the cathode active material layer.

A mixing ratio of the graphene and the carbon black may be a weight ratio of 1:100 to 1:3.

The carbon black may be denka black, acetylene black, ketjen black, or a combination thereof.

The material mix density may be 4.3 g/cc to 4.5 g/cc.

Another embodiment provides a lithium secondary battery including the cathode; an anode including an anode active material; and an electrolyte.

Other details of the embodiments of the present invention are included in the following detailed description.

### Advantageous Effects

The lithium secondary battery cathode according to an embodiment may provide a lithium secondary battery having improved cycle-life characteristics, rate capability, capacity, and stability.

### DESCRIPTION OF THE DRAWINGS

FIG. 1 is a schematic view of a structure of a lithium secondary battery according to an embodiment of the present invention.

FIG. 2 is a photograph showing a criterion for evaluating an electrode breakage.

FIG. 3 is a graph showing capacity retentions of half-cells according to Example 1 and Comparative Example 1.

FIG. 4 is a graph showing capacity retentions of half-cells according to Reference Example 1 and Comparative Example 2.

FIG. 5 is a graph showing capacity retentions of half-cells according to Reference Example 2 and Comparative Example 3.

FIG. 6 is a graph showing capacity retentions of half-cells according to Example 1 and Comparative Example 4.

FIG. 7 is a graph showing rate capability of half-cells according to Example 1 and Comparative Example 1.

FIG. 8 is a graph showing slurry pellet density % of Example 1 and Reference Examples 4, 5, 3, and 6 relative to slurry pellet density of Reference Example 6.

FIG. 9 is a graph showing charge capacities of half-cells according to Comparative Examples 8 to 10.

FIG. 10 is a graph showing charge capacities of half-cells according to Comparative Examples 11 and 12 and Example 1.

FIG. 11 is a graph showing charge capacities of half-cells according to Comparative Examples 13 and 14 and Reference Example 4.

FIG. 12 is a graph showing rate capability according to Comparative Examples 8 and 11.

FIG. 13 is a graph showing rate capability according to Comparative Examples 9 and 12.

FIG. 14 is a graph showing rate capability according to Example 1 and Comparative Example 10.

### MODE FOR INVENTION

Hereinafter, embodiments of the present invention will be described in detail. However, the present invention is not limited thereto, and the present invention is only defined by the scope of the following claims.

A lithium secondary battery cathode according to an embodiment of the present invention includes a current collector and a cathode active material layer disposed on the current collector and including a cathode active material, a binder, graphene, and carbon black wherein a material mix density (active mass density) is greater than or equal to 4.3 g/cc.

In an embodiment, the cathode uses graphene, which refers to a two-dimensional material formed of one layer of graphite having a plate-shape structure and is a plate material having a different shape from a flake.

The specific surface area of this graphene is about 60 m²/g to 80 m²/g, which is much larger than the specific surface area (about 20 m²/g or less) of the flake carbon-based material and thus a sufficient contact area with an active material may be ensured, sufficient conductivity may be ensured, and the material having a very thin thickness (for example, 1 nm to 20 nm) may provide the cathode with sufficient conductivity for the same weight.

On the other hand, since flake-shaped graphite (e.g., SFG6 Timcal) has a specific surface area of about 17 m²/g, which is lower than the specific surface area of graphene and a thickness of about 600 nm, which is too thick, it is difficult to secure the sufficient conductivity for the same weight, and resultantly cycle-life characteristic may be decreased.

Further, if only carbon black which is a particle-shape conductive material is used without using graphene, a material mix density of the cathode cannot be greater than or equal to 4.3 g/cc in a single compression process, and even if the density of the cathode is set to greater than or equal to 4.3 g/cc through a multiple compression process, since the particle-shape conductive material blocks pores of the electrode, lithium mobility may be deteriorated and performance may be reduced, which is not suitable.

In the cathode active material layer, an amount of the graphene may be 0.01 wt % to 0.29 wt % based on 100 wt % of the cathode active material layer. When the amount of the graphene is within the above range, capacity of the battery including the cathode having a material mix density of greater than or equal to 4.3 g/cc may be improved.

When plate-shape graphite other than graphene is used, an excess amount of greater than about 0.5 wt % should be used, which results in a relatively small amount of the cathode active material in the cathode active material layer, which may result in a decrease in capacity. In addition, excessive use of such plate-shape graphite may decrease lithium mobility due to a basal plane of the graphite, thereby reducing the capacity/rate capability.

An amount of the carbon black may be 1 wt % to 3 wt %, in an embodiment, 1 wt % to 2 wt % based on 100 wt % of the cathode active material layer. When the amount of the carbon black is included within the ranges, capacity and efficiency of a battery including a cathode having a high material mix density of greater than or equal to 4.3 g/cc may be improved.

A mixing ratio of the graphene and the carbon black may be a weight ratio of 1:100 to 1:3, in an embodiment, a weight ratio of 1:50 to 1:10. When the mixing ratio of the graphene and the carbon black is within the above range, lithium ion mobility may be more appropriately improved, and lithium ion conductivity may be further improved.

The carbon black may be denka black, acetylene black, ketjen black, or combination thereof.

When the graphene and carbon black are mix-used in the cathode, rate capability, cycle-life characteristics, and rate capability may be improved and particularly, a cathode having a material mix density of greater than or equal to about 4.3 g/cc, and specifically 4.3 g/cc to 4.5 g/cc may be obtained. When the material mix density of the cathode greater than or equal to about 4.3 g/cc, proper capacity, cycle-life characteristics, and rate capability may not be obtained when only carbon black such as denka black is used for the cathode.

In the cathode active material layer, an amount of the cathode active material may be 93.5 wt % to 97.99 wt % based on a total weight of the cathode active material layer. The amount of the binder may be 1 wt % to 3 wt % based on a total weight of the cathode active material layer.

The cathode active material may include lithiated intercalation compounds that reversibly intercalate and deintercalate lithium. Specifically, one or more composite oxides of a metal selected from cobalt, manganese, nickel, and a combination thereof, and lithium may be used. More specifically, the compounds represented by one of the following chemical formulae may be used. LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0≤b≤0.5, 0≤c≤0.05); LiₐE_{2-b}X_{b}O_{4-c}D_{c} (0≤b≤0.5, 0≤c≤0.05); LiₐNi_{1-b-c}Co_{b}X_{c}D_{α} (0.90≤a≤1.8, 0≤b≤0.5, 0≤c≤0.5, 0≤α≤2); LiₐNi_{1-b-c}Co_{b}X_{c}O_{2-α}T_{α} (0.90≤a≤1.8, 0≤b≤0.5, 0≤c≤0.05, 0<α<2); LiₐNi_{1-b-c}Co_{b}X_{c}O_{2-α}T₂ (0.90≤a≤1.8, 0≤b≤0.5, 0≤c≤0.05, 0<α<2); LiₐNi_{1-b-c}Mn_{b}X_{c}D_{α} (0.90≤a≤1.8, 0≤b≤0.5, 0≤c≤0.05, 0<α≤2); LiₐNi_{1-b-c}Mn_{b}X_{c}O_{2-α}T_{α} (0.90≤a≤1.8, 0≤b≤0.5, 0≤c≤0.05, 0<α<2); LiₐNi_{1-b-c}Mn_{b}X_{c}O_{2-α}T₂ (0.90≤a≤1.8, 0≤b≤0.5, 0≤c≤0.05, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1) LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); LiₐFePO₄(0.90≤a≤1.8)

In the above chemical formulae, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The compounds may have a coating layer on the surface, or may be mixed with another compound having a coating layer. The coating layer may include at least one coating element compound selected from the group consisting of an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed by a method having no adverse influence on properties of a cathode active material by using these elements in the compound (e.g., spray coating, dipping, etc.), but is not illustrated in more detail since it is well-known to those skilled in the related field.

The binder may be polyvinylalcohol, carboxylmethylcellulose, hydroxypropylcellulose, diacetylcellulose, polyvinylchloride, polyvinylfluoride, polyvinylpyrrolidone, polyurethane, polytetrafluoroethylene, polyvinylidene fluoride, polyethylene, polypropylene, a styrene-butadiene rubber, an acrylated styrene butadiene rubber, an epoxy resin, nylon, and the like, but is not limited thereto.

The current collector may be Al, but is not limited thereto.

Another embodiment of the present invention provides a lithium secondary battery including the cathode, an anode including an anode active material, and an electrolyte.

The anode includes a current collector and an anode active material layer disposed on the current collector and including an anode active material.

The anode active material include a material that reversibly intercalates/deintercalates lithium ions, a lithium metal, a lithium metal alloy, a material capable of doping and dedoping lithium, or a transition metal oxide.

The material that reversibly intercalates/deintercalates lithium ions is a carbon material, and may be any generally-used carbon-based anode active material in a lithium ion secondary battery, and examples thereof may be crystalline carbon, amorphous carbon, or a combination thereof. Examples of the crystalline carbon may be a graphite such as a unspecified shape, sheet-shaped, flake, spherical shaped or fiber-shaped natural graphite or artificial graphite, and examples of the amorphous carbon may be soft carbon or hard carbon, a mesophase pitch carbonized product, fired cokes, and the like.

The lithium metal alloy may include an alloy of lithium and a metal selected from the group consisting of Na, K, Rb, Cs, Fr, Be, Mg, Ca, Sr, Si, Sb, Pb, In, Zn, Ba, Ra, Ge, Al, and Sn.

The material capable of doping and dedoping lithium may be Si, SiOₓ (0<x<2), a Si-Q alloy (wherein Q is an element selected from the group consisting of an alkali metal, an alkaline-earth metal, a Group 13 element, a Group 14 element, a Group 15 element, a Group 16 element, a transition element, a rare earth element, and a combination thereof, and not Si), Sn, SnO₂, a Sn-R alloy (wherein R is an element selected from the group consisting of an alkali metal, an alkaline-earth metal, a Group 13 element, a Group 14 element, a Group 15 element, a Group 16 element, a transition element, a rare earth element, and a combination thereof, and not Sn), and the like, and at least one thereof may be mixed with SiO₂. The elements Q and R may be selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

The transition metal oxide may be vanadium oxide, lithium vanadium oxide, or lithium titanium oxide.

In the anode active material layer, an amount of the anode active material may be 95 wt % to 99 wt % based on a total amount of the anode active material layer.

In an embodiment of the present invention, the anode active material layer may include a binder, and optionally a conductive material. In the anode active material layer, an amount of the binder may be 1 wt % to 5 wt % based on a total amount of the anode active material layer. When the conductive material is further included, 90 wt % to 98 wt % of the anode active material, 1 wt % to 5 wt % of the binder, and 1 wt % to 5 wt % of the conductive material may be used.

The binder serves to adhere the anode active material particles to each other and to adhere the anode active material to a current collector. The binder includes a non-water-soluble binder, a water-soluble binder, or a combination thereof.

The non-water-soluble binder may be selected from polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof.

The water-soluble binder may be selected from a styrene-butadiene rubber, an acrylated styrene-butadiene rubber (SBR), an acrylonitrile-butadiene rubber, an acrylic rubber, a butyl rubber, a fluorine rubber, an ethylenepropylene copolymer, polyepichlorohydrin, polyphosphazene, polyacrylonitrile, polystyrene, an ethylenepropylenediene copolymer, polyvinylpyridine, chlorosulfonated polyethylene, latex, a polyester resin, an ester resin, an acrylic resin, a phenolic resin, an epoxy resin, polyvinylalcohol, and a combination thereof.

When the water-soluble binder is used as the anode binder, a cellulose-based compound may be further used to provide viscosity as a thickener. The cellulose-based compound includes one or more of carboxylmethyl cellulose, hydroxypropylmethyl cellulose, methyl cellulose, or alkali metal salts thereof. The alkali metal may be Na, K, or Li. Such a thickener may be included in an amount of 0.1 parts by weight to 3 parts by weight based on 100 parts by weight of the anode active material.

Examples of the conductive material include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

The current collector may include one selected from a copper foil, a nickel foil, a stainless steel foil, a titanium foil, a nickel foam, a copper foam, a polymer substrate coated with a conductive metal, and a combination thereof.

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include methyl acetate, ethyl acetate, n-propyl acetate, dimethyl acetate, methyl propionate, ethyl propionate, decanolide, mevalonolactone, caprolactone, and the like. The ether-based solvent may include dibutyl ether, tetraglyme, diglyme, dimethoxyethane, 2-methyltetrahydrofuran, tetrahydrofuran, and the like. In addition, the ketone-based solvent may be cyclohexanone, and the like. The alcohol based solvent may include ethanol, isopropyl alcohol, and the like, and the aprotic solvent may include nitriles such as R-CN (wherein R is a C2 to C20 linear, branched, or cyclic hydrocarbon group, a double bond, an aromatic ring, or an ether bond), and the like, amides such as dimethyl formamide, and the like, dioxolanes such as 1,3-dioxolane, and the like, sulfolanes, and the like.

The organic solvent may be used alone or in a mixture and when the organic solvent is used in a mixture, a mixture ratio may be controlled in accordance with a desirable battery performance, which may be understood by a person having an ordinary skill in this art.

In addition, the carbonate-based solvent may include a mixture of a cyclic carbonate and a linear (chain) carbonate. In this case, when the cyclic carbonate and the linear carbonate may be mixed together in a volume ratio of 1:1 to 1:9, performance of an electrolyte solution may be enhanced.

The organic solvent may further include an aromatic hydrocarbon-based organic solvent in addition to the carbonate-based solvent. Herein, the carbonate-based solvent and the aromatic hydrocarbon-based organic solvent may be mixed in a volume ratio of 1:1 to 30:1.

The aromatic hydrocarbon-based organic solvent may be an aromatic hydrocarbon-based compound of Chemical Formula 1.

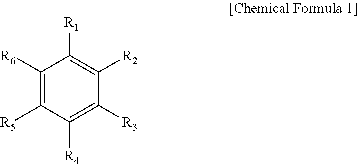

In Chemical Formula 1, R₁ to R₆ are the same or different and are selected from the group consisting of hydrogen, a halogen, a C1 to C10 alkyl group, a haloalkyl group, and a combination thereof.

Specific examples of the aromatic hydrocarbon-based organic solvent may be selected from the group consisting of benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include an additive of vinylene carbonate or an ethylene carbonate-based compound of Chemical Formula 2 in order to improve cycle-life of a battery as an additive for improving cycle-life.

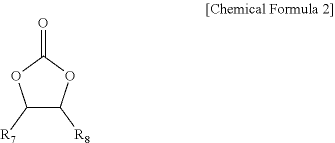

In Chemical Formula 2, R₇ and R₈ are the same or different and selected from hydrogen, a halogen, a cyano group (CN), a nitro group (NO₂), and a fluorinated C1 to C5 alkyl group, provided that at least one of R₇ and R₈ is selected from a halogen, a cyano group (CN), a nitro group (NO₂), and a fluorinated C1 to C5 alkyl group, and R₇ and R₈ are not simultaneously hydrogen.

Examples of the ethylene carbonate-based compound may be difluoro ethylene carbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving cycle-life may be used within an appropriate range.

The lithium salt dissolved in an organic solvent supplies a battery with lithium ions, basically operates the lithium secondary battery, and improves transportation of the lithium ions between a cathode and an anode. Examples of the lithium salt include one, or two or more selected from Li PF₆, LiBF₄, LiSbF₆, LiAsF₆, LiN(SO₂C₂F₅)₂, Li(CF₃SO₂)₂N, LiN (SO₃C₂F₅)₂, LiC₄F₉SO₃, LiClO₄, LiAlO₂, LiAlCl₄, LiN(CₓF₂ₓ₊₁SO₂)(C_{y}F_{2y±1}SO₂), wherein, x and y are natural numbers, for example an integer ranging from 1 to 20), LiCl, LiI, and LiB(C₂O₄)₂ (lithium bis(oxalato) borate: LiBOB), as a supporting electrolyte salt. A concentration of the lithium salt may range from 0.1 M to 2.0 M. When the lithium salt is included at the above concentration range, an electrolyte may have excellent performance and lithium ions may be effectively moved due to optimal electrolyte conductivity and viscosity.

A separator may be disposed between the cathode and the anode depending on a type of a lithium secondary battery. The separator may use polyethylene, polypropylene, polyvinylidene fluoride or multi-layers thereof having two or more layers and may be a mixed multilayer such as a polyethylene/polypropylene double-layered separator, a polyethylene/polypropylene/polyethylene triple-layered separator, a polypropylene/polyethylene/polypropylene triple-layered separator, and the like.

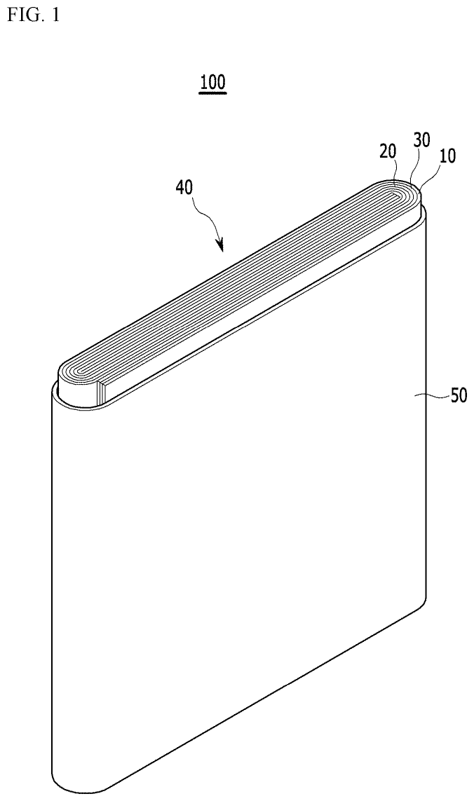

FIG. 1 is an exploded perspective view of a lithium secondary battery according to one embodiment. The lithium secondary battery according to an embodiment is illustrated as a prismatic battery but is not limited thereto and may include variously-shaped batteries such as a cylindrical battery, a pouch battery, and the like.

Referring to FIG. 1, a lithium secondary battery 100 according to an embodiment may include an electrode assembly 40 manufactured by winding a separator 30 disposed between a cathode 10 and an anode 20 and a case 50 housing the electrode assembly 40. An electrolyte (not shown) may be impregnated in the cathode 10, the anode 20, and the separator 30.

Hereinafter, examples of the present invention and comparative examples are described. These examples, however, are not in any sense to be interpreted as limiting the scope of the invention.

### EXAMPLE 1

97.8 wt % of a LiCoO₂ cathode active material, 0.1 wt % of graphene, 1.0 wt % of denka black, and 1.1 wt % of polyvinylidene fluoride were mixed in an N-methyl pyrrolidone solvent to prepare cathode active material slurry.

The cathode active material slurry was coated on both surfaces of an Al foil current collector at a loading level sum of 50 mg/cm² on both surfaces and dried. Subsequently, the dried product was compressed under a condition of maintaining a compressor roller gap of 30 μm to manufacture a cathode having a cathode active material layer thickness (a thickness sum of both surfaces) of 116 μm and a material mix density of 4.3 g/cc.

The cathode was used along with a lithium metal counter electrode and an electrolyte to manufacture a coin-type half-cell in a common method. The electrolyte was prepared by using a mixed solvent of ethylene carbonate and dimethyl carbonate (a volume ratio of 50:50) in which 1.5 M LiPF₆ was dissolved.

### EXAMPLE 2

The cathode active material slurry according to Example 1 was coated at a loading level of 50 mg/cm² on an Al foil current collector and then, dried. Subsequently, the dried product was compressed under a condition of maintaining a compressor roller gap of 20 μm to manufacture a cathode having a cathode active material layer thickness (a thickness sum on both surfaces) of 119 μm and a material mix density of 4.36 g/cc.

The cathode was used to manufacture a half-cell in the same method as Example 1.

### EXAMPLE 3

The cathode active material slurry according to Example 1 was coated at a loading level of 50 mg/cm² on an Al foil current collector and then, dried. Subsequently, the dried product was compressed under a condition of maintaining a compressor roller gap of 30 μm to manufacture a cathode having a cathode active material layer thickness (a thickness sum on both surfaces) of 119 μm and a material mix density of 4.38 g/cc.

The cathode was used to manufacture a half-cell in the same method as Example 1.

### COMPARATIVE EXAMPLE 1

97.8 wt % of a LiCoO₂ cathode active material, 1.1 wt % of denka black, and 1.1 wt % of polyvinylidene fluoride were mixed in an N-methyl pyrrolidone solvent to prepare cathode active material slurry.

The cathode active material slurry was coated on an Al foil current collector at a loading level of 50 mg/cm² and dried. Subsequently, the dried product was compressed under a condition of maintaining a compressor roller gap of 30 μm to manufacture a cathode having a cathode active material layer thickness (a thickness sum of both surfaces) of 116 μm and a material mix density of 4.3 g/cc.

The cathode was used along with a lithium metal counter electrode and an electrolyte to manufacture a coin-type half-cell in a common method. The electrolyte was prepared by using a mixed solvent of ethylene carbonate and dimethyl carbonate (a volume ratio of 50:50) in which 1.5 M LiPF₆ was dissolved.

### COMPARATIVE EXAMPLE 2

The cathode active material slurry of Comparative Example 1 was prepared. The cathode active material slurry was coated on an Al foil current collector at a loading level of 50 mg/cm² and then, dried. Subsequently, the dried product was compressed under a condition of maintaining a compressor roller gap of 70 μm to manufacture a cathode having a cathode active material layer thickness (a thickness sum on both surfaces) of 122 μm and a material mix density of 4.1 g/cc.

A half-cell was manufactured by using the cathode in the same method as Comparative Example 1.

### Comparative Example 3

The cathode active material slurry of Comparative Example 1 was prepared. The cathode active material slurry was coated on an Al foil current collector at a loading level of 50 mg/cm² and then, dried. Subsequently, the dried product was compressed under a condition of maintaining a compressor roller gap of 30 μm to manufacture a cathode having a cathode active material layer thickness (a thickness sum of both surfaces) of 116 μm and a material mix density of 4.3 g/cc.

A half-cell was manufactured by using the cathode in the same method as Comparative Example 1.

### COMPARATIVE EXAMPLE 4

97.6 wt % of a LiCoO₂ cathode active material, 0.3 wt % of flake graphite, 1.0 wt % of denka black, and 1.1 wt % of polyvinylidene fluoride were mixed in an N-methyl pyrrolidone solvent to prepare cathode active material slurry.

The cathode active material slurry was coated to be 100 μm thick on an Al foil current collector at a loading of 50 mg/cm² and then, dried. Subsequently, the dried product was compressed under a condition of maintaining a compressor roller gap of 60 μm to manufacture a cathode having a cathode active material layer thickness (a thickness sum of both surfaces) of 120 μm and a material mix density of 4.15 g/cc.

A half-cell was manufactured by using the cathode in the same method as Comparative Example 1.

### COMPARATIVE EXAMPLE 5

97.8 wt % of a LiCoO₂ cathode active material, 1.1 wt % of denka black, and 1.1 wt % of polyvinylidene fluoride were mixed in an N-methyl pyrrolidone solvent to prepare cathode active material slurry.

The cathode active material slurry was coated on an Al foil current collector at a loading level of 50 mg/cm² and dried. Subsequently, the dried product was compressed under a condition of maintaining a compressor roller gap of 20 μm to manufacture a cathode having a cathode active material layer thickness (a thickness sum of both surfaces) of 120 μm and a material mix density of 4.31 g/cc.

A half-cell was manufactured by using the cathode in the same method as Comparative Example 1.

### COMPARATIVE EXAMPLE 6

97.8 wt % of a LiCoO₂ cathode active material, 1.1 wt % of denka black, and 1.1 wt % of polyvinylidene fluoride were mixed in an N-methyl pyrrolidone solvent to prepare cathode active material slurry.

The cathode active material slurry was coated on an Al foil current collector at a loading level of 50 mg/cm² and dried. Subsequently, the dried product was compressed under a condition of maintaining a compressor roller gap of 30 μm to manufacture a cathode having a cathode active material layer thickness (a thickness sum of both surfaces) of 120 μm and a material mix density of 4.34 g/cc.

A half-cell was manufactured by using the cathode in the same method as Comparative Example 1.

### COMPARATIVE EXAMPLE 7

97.8 wt % of a LiCoO₂ cathode active material, 1.1 wt % of denka black, and 1.1 wt % of polyvinylidene fluoride were mixed in an N-methyl pyrrolidone solvent to prepare cathode active material slurry.

The cathode active material slurry was coated to be 100 μm thick on an Al foil current collector at a loading level of 50 mg/cm² and dried. Subsequently, the dried product was compressed under a condition of maintaining a compressor roller gap of 30 μm to manufacture a cathode having a cathode active material layer thickness (a thickness sum of both surfaces) of 120 μm and a material mix density of 4.25 g/cc.

A half-cell was manufactured by using the cathode in the same method as Comparative Example 1.

### REFERENCE EXAMPLE 1

The cathode active material slurry according to Example 1 was coated on an Al foil current collector at a loading level of 50 mg/cm² and then, dried. Subsequently, the dried product was compressed under a condition of maintaining a compressor roller gap of 70 μm to manufacture a cathode having a cathode active material layer thickness (a thickness sum of both surfaces) of 122 μm and a material mix density of 4.1 g/cc.

A half-cell was manufactured by using the cathode in the same method as Example 1.

### REFERENCE EXAMPLE 2

The cathode active material slurry according to Example 1 was coated on an Al foil current collector at a loading level of 50 mg/cm² and then, dried. Subsequently, the dried product was compressed under a condition of maintaining a compressor roller gap of 50 μm to manufacture a cathode having a cathode active material layer thickness (a thickness sum of both surfaces) of 119 μm and a material mix density of 4.2 g/cc.

A half-cell was manufactured by using the cathode in the same method as Example 1.

### REFERENCE EXAMPLE 3

96.9 wt % of a LiCoO₂ cathode active material, 1.0 wt % of graphene, 1.0 wt % of denka black, and 1.1 wt % of polyvinylidene fluoride were mixed in an N-methyl pyrrolidone solvent to prepare cathode active material slurry.

The cathode active material slurry was coated on an Al foil current collector at a loading level of 50 mg/cm² and dried. Subsequently, the dried product was compressed under a condition of maintaining a compressor roller gap of 30 μm to manufacture a cathode having a cathode active material layer thickness (a thickness sum of both surfaces) of 50 μm and a material mix density of 4.3 g/cc.

A half-cell was manufactured by using the cathode in the same method as Example 1.

### REFERENCE EXAMPLE 4

97.6 wt % of a LiCoO₂ cathode active material, 0.3 wt % of graphene, 1.0 wt % of denka black, and 1.1 wt % of polyvinylidene fluoride were mixed in an N-methyl pyrrolidone solvent to prepare cathode active material slurry.

The cathode active material slurry was coated on an Al foil current collector at a loading level of 50 mg/cm² and dried. Subsequently, the dried product was compressed under a condition of maintaining a compressor roller gap of 30 μm to manufacture a cathode having a cathode active material layer thickness (a thickness sum of both surfaces) of 116 μm and a material mix density of 4.3 g/cc.

A half-cell was manufactured by using the cathode in the same method as Example 1.

### Reference Example 5

97.4 wt % of a LiCoO₂ cathode active material, 0.5 wt % of graphene, 1.0 wt % of denka black, and 1.1 wt % of polyvinylidene fluoride were mixed in an N-methyl pyrrolidone solvent to prepare cathode active material slurry.

The cathode active material slurry was coated on an Al foil current collector at a loading level of 50 mg/cm² and dried. Subsequently, the dried product was compressed under a condition of maintaining a compressor roller gap of 30 μm to manufacture a cathode having a cathode active material layer thickness (a thickness sum of both surfaces) of 116 μm and a material mix density of 4.3 g/cc.

A half-cell was manufactured by using the cathode in the same method as Example 1.

*Electrode Bending Evaluation

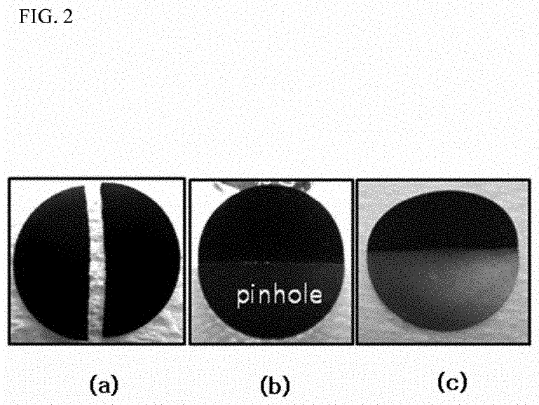

After bending both ends of the cathodes according to Examples 2 and 3 and Comparative Examples 5 to 7 up to 90°, their states were examined under a light. The results of (a) of FIG. 2 (bent) and (b) of FIG. 2 (generation of a pinhole where broken or bent) were evaluated as No Good, but the result of (c) of FIG. 2 was evaluated as Good, and all the results are shown in Table 1.

TABLE 1

| | Roller gap | Material mix density | |
|---|---|---|---|
| | (μm) | (g/cc) | Results |
| Example 2 | 20 | 4.36 | Good |
| Example 3 | 30 | 4.38 | Good |
| Comparative Example 5 | 20 | 4.31 | No Good |
| Comparative Example 6 | 30 | 4.34 | No Good |
| Comparative Example 7 | 30 | 4.25 | No Good |

Referring to the results of Table 1, the cathodes according to Examples 2 and 3 may be used to manufacture an appropriately-sized jelly roll battery cell, while the cathodes according to Comparative Examples 5 to 7 may not.

*Evaluation of Cycle-Life Characteristics

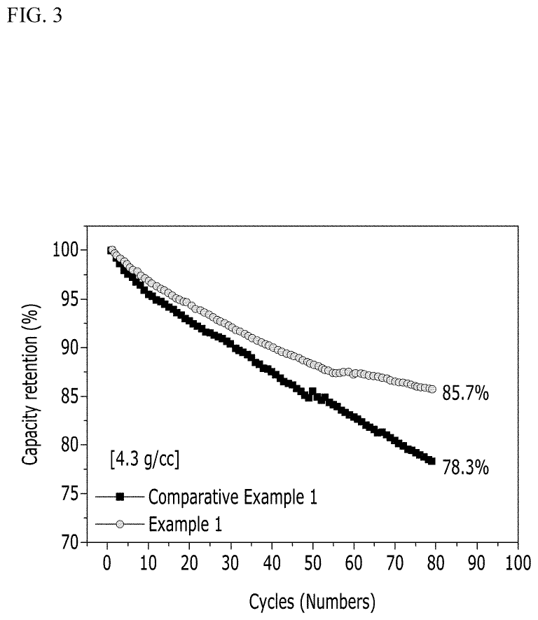

The half-cells according to Example 1, Comparative Examples 1 to 3, and Reference Examples 1 and 2 were 80 times charged and discharged at 1 C, and then, their capacity retentions were measured, and the results are shown in FIGS. 3 to FIG. 5.

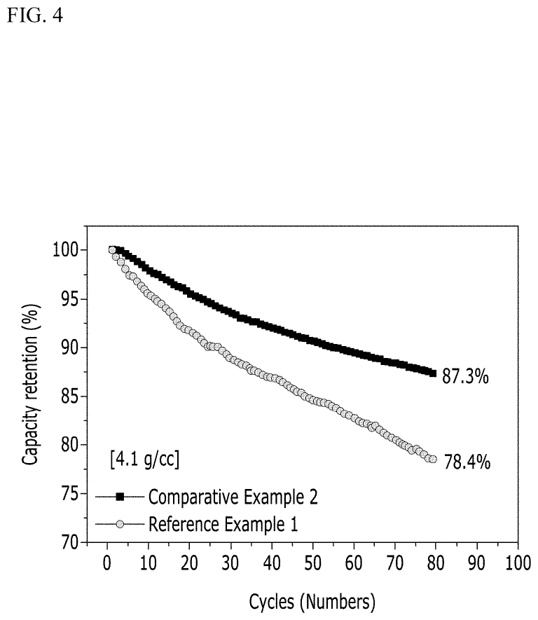

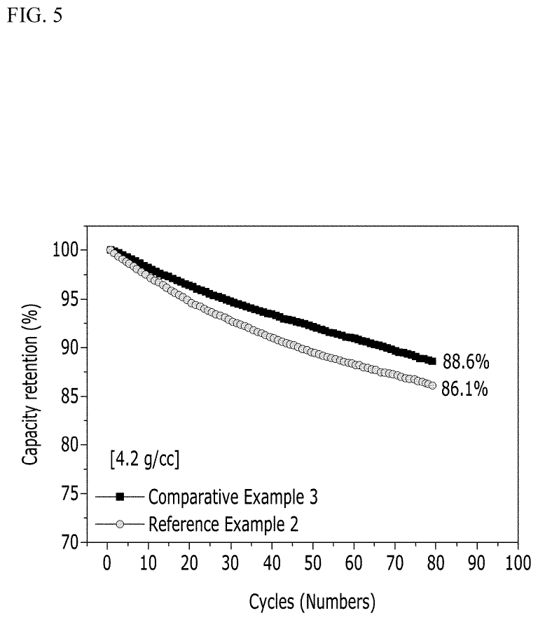

FIG. 3 shows the results of Example 1 and Comparative Example 1, FIG. 4 shows the results of Reference Example 1 and Comparative Example 2, and FIG. 5 shows the results of Reference Example 2 and Comparative Example 3.

As shown in FIGS. 3 to 5, when the material mix density was in a range of 4.1 g/cc and 4.2 g/cc, Reference Examples 1 and 2 using graphene and denka black exhibited a low capacity retention compared with Comparative Examples 2 and 3 only using denka black, but when the material mix density was high like 4.3 g/cc, Example 1 using graphene and denka black showed an excellent capacity retention compared with Comparative Example 1 only using denka black.

Particularly, Comparative Example 1 exhibited a capacity retention of 78.3%, when 80 times charged and discharged, which is lower than 80% of an actually applicable capacity retention.

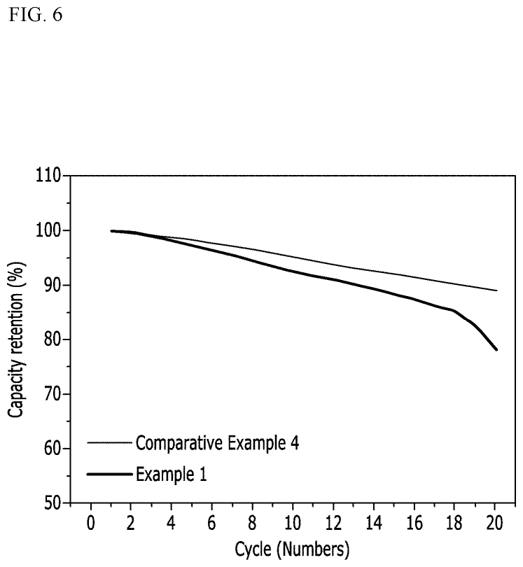

In addition, the half-cells according to Example 1 and Comparative Example 4 were 20 times charged and discharged at 1 C, and then, their capacity retentions were measured, and the results are shown in FIG. 6. As shown in FIG. 6, Comparative Example 4 using neither denka black nor graphene but flake graphite exhibited a deteriorated capacity retention compared with Example 1 using denka black and graphene.

*Evaluation of Rate Capability

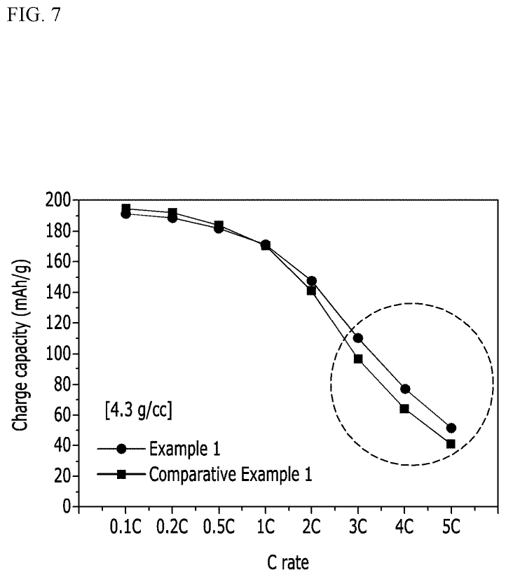

The half-cells according to Example 1 and Comparative Example 1 were respectively once charged and discharged by changing a C-rate into 0.1 C, 0.2 C, 0.5 C, 1 C, 2 C, 3 C, 4 C, and 5 C, and their charge capacities were measured. The results are shown in FIG. 7. As shown in FIG. 7, Example 1 showed similar or a little low charge capacity at a low rate but high charge capacity at a high rate of greater than or equal to 2 C compared with Comparative Example 1.

*Measurement of Pellet Density

Each cathode active material slurry according to Example 1 and Reference Examples 3 to 5 was manufactured into pellets by applying a press force thereto.

Specifically, the pellets were respectively manufactured by pouring each cathode active material slurry into a container made of an aluminum foil and completely drying it in a 110° C. oven. The dried slurry powder was finely pulverized with a mortar and pestle and sieved with a 250 mesh sieve. The sieved product was weighed by 1 g, put in a pellet jig, and pressed respectively under 0.8 ton/cm², 1.6 ton/cm², 2.4 ton/cm² and 3.2 ton/cm² for 30 seconds to manufacture slurry pellets.

The slurry pellets were allowed to stand for 24 hours, and a weight and a thickness of the slurry pellets were measured. The measured weight and thickness were used to calculate slurry pellet density.

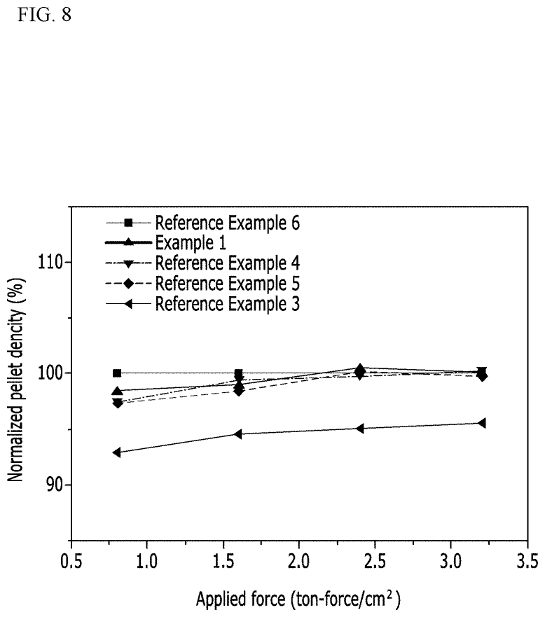

On the other hand, 98.9 wt % of LiCoO₂ and 1.1 wt % of polyvinylidene fluoride were mixed in an N-methyl pyrrolidone solvent to prepare cathode active material slurry, and this slurry was used to manufacture a slurry pellet, and then, density of this slurry pellet was measured. This slurry pellet density was converted into 100% and shown as Reference Example 6 in FIG. 8.

Based on 100% of the slurry pellet density of Reference Example 6, slurry pellet densities of Example 1 and Reference Examples 4 to 6 were calculated as a percentage, and the slurry pellet densities as percentages depending on a pressure applied during the manufacture of the pellets are shown in FIG. 8.

As shown in FIG. 8, Example 1 and Reference Examples 5 and 6 using 0.1 wt % to 0.5 wt % of graphene and 1.0 wt % of denka black showed a similar slurry pellet density to that of Reference Example 6 not using graphene and denka black, but Reference Example 3 excessively using 1.0 wt % of graphene showed no similar slurry pellet density to that of Reference Example 6. Referring to the results, when graphene was excessively used, a high material mix density which is advantage of the present invention may not be obtained, and accordingly, a battery cell having a high energy density (Wh/L) may not be provided.

### COMPARATIVE EXAMPLE 8

97.9 wt % of a LiCoO₂ cathode active material, 1.0 wt % of denka black, and 1.1 wt % of polyvinylidene fluoride were mixed in an N-methyl pyrrolidone solvent to prepare cathode active material slurry.

The cathode active material slurry was coated on an Al foil current collector at a loading level of 50 mg/cm² and dried. Subsequently, the dried product was compressed under a condition of maintaining a compressor roller gap of 30 μm to manufacture a cathode having a cathode active material layer thickness (a thickness sum of both surfaces) of 135 μm and a material mix density of 3.7 g/cc.

A half-cell was manufactured by using the cathode in the same method as Comparative Example 1.

### Comparative Example 9

The cathode active material slurry of Comparative Example 8 was prepared. The cathode active material slurry was coated on an Al foil current collector at a loading level of 50 mg/cm² and dried. Subsequently, the dried product was compressed to manufacture a cathode having a cathode active material layer thickness (a thickness sum of both surfaces) of 125 μm and a material mix density of 4.0 g/cc.

A half-cell was manufactured by using the cathode in the same method as Comparative Example 1.

### Comparative Example 10

The cathode active material slurry of Comparative Example 8 was prepared. The cathode active material slurry was coated on an Al foil current collector at a loading level of 50 mg/cm² and dried. Subsequently, the dried product was compressed to manufacture a cathode having a cathode active material layer thickness (a thickness sum of both surfaces) of 116 μm and a material mix density of 4.3 g/cc.

A half-cell was manufactured by using the cathode in the same method as Comparative Example 1.

### COMPARATIVE EXAMPLE 11

97.8 wt % of a LiCoO₂ cathode active material, 0.1 wt % of graphene, 1.0 wt % of denka black, and 1.1 wt % of polyvinylidene fluoride were mixed in an N-methyl pyrrolidone solvent to prepare cathode active material slurry.

The cathode active material slurry was coated on an Al foil current collector at a loading level of 50 mg/cm² and dried. Subsequently, the dried product was compressed to manufacture a cathode having a cathode active material layer thickness (a thickness sum of both surfaces) of 135 μm and a material mix density of 3.7 g/cc.

A half-cell was manufactured by using the cathode in the same method as Comparative Example 1.

### COMPARATIVE EXAMPLE 12

The cathode active material slurry of Comparative Example 11 was prepared. The cathode active material slurry was coated on an Al foil current collector at a loading level of 50 mg/cm² and dried. Subsequently, the dried product was compressed to manufacture a cathode having a cathode active material layer thickness (a thickness sum of both surfaces) of 125 μm and a material mix density of 4.0 g/cc.

### COMPARATIVE EXAMPLE 13

97.6 wt % of a LiCoO₂ cathode active material, 0.3 wt % of graphene, 1.0 wt % of denka black, and 1.1 wt % of polyvinylidene fluoride were mixed in an N-methyl pyrrolidone solvent to prepare cathode active material slurry.

The cathode active material slurry was coated on an Al foil current collector at a loading level of 50 mg/cm² and dried. Subsequently, the dried product was compressed to manufacture a cathode having a cathode active material layer thickness (a thickness sum of both surfaces) of 135 μm and a material mix density of 3.7 g/cc.

A half-cell was manufactured by using the cathode in the same method as Comparative Example 1.

### COMPARATIVE EXAMPLE 14

The cathode active material slurry of Comparative Example 11 was prepared. The cathode active material slurry was coated on an Al foil current collector at a loading level of 50 mg/cm² and dried. Subsequently, the dried product was compressed to manufacture a cathode having a cathode active material layer thickness (a thickness sum of both surfaces) of 125 μm and a material mix density of 4.0 g/cc.

A half-cell was manufactured by using the cathode in the same method as Comparative Example 1.

*Evaluation of Capacity Characteristics

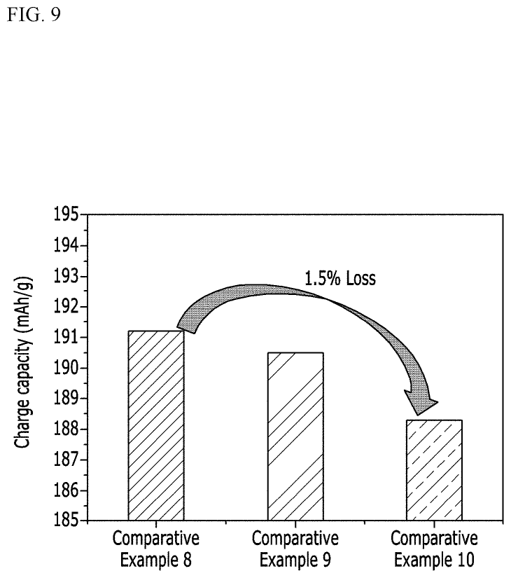

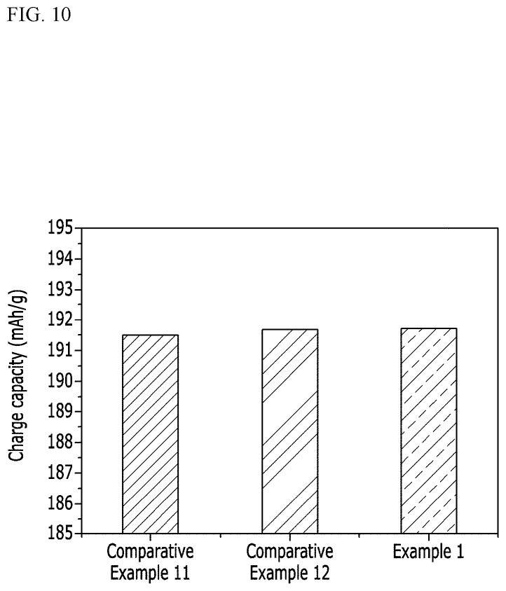

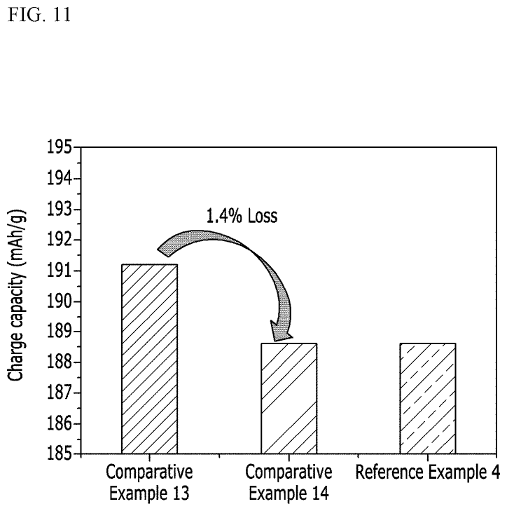

The half-cells according to Example 1 and Reference Example 4 were once charged and discharged at 0.1 C, and their discharge capacities were measured for comparison with those of the half-cells according to Comparative Examples 8 to 14. The results are shown in FIGS. 9 to 11. FIG. 9 shows the results of Comparative Examples 8 to 10, FIG. 10 shows the results of Comparative Examples 11 and 12 and Example 1, and FIG. 11 shows the results of Comparative Examples 13 and 14 and Reference Example 4.

As shown in FIG. 9, when only denka black was used like in Comparative Examples 8 to 10, the charge capacity rather decreased by 1.5%, even though the material mix density was increased from 3.7 g/cc into 4.3 g/cc. On the contrary, as shown in FIG. 10, when denka black and graphene were used together, the charge capacity did not decrease, even though the material mix density was increased.

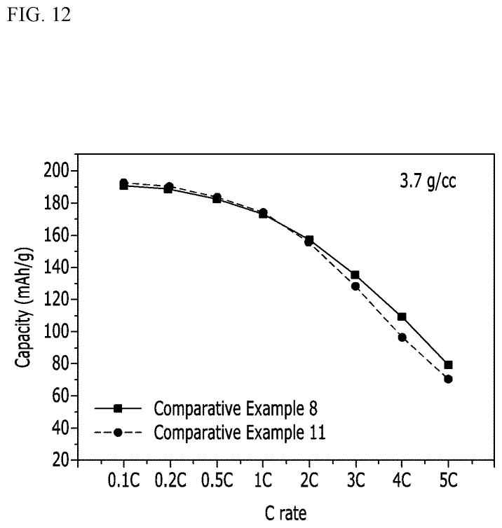

In addition, as shown in FIG. 12, even though denka black was used along with graphene, when the graphene was excessively used in an amount of 0.3 wt %, the charge capacity decreased by 1.4%, even though the material mix density was increased (Reference Example 4: a material mix density of 4.3 g/cc, Comparative Example 14: a material mix density of 4.0 g/cc). In other words, Reference Example 4 using 0.3 wt % of graphene exhibited a high slurry pellet, as shown in FIG. 8, but as shown in FIG. 12, the capacity decreased. Furthermore, Reference Example 5 using 0.5 wt % of graphene exhibited similarly deteriorated charge capacity to that of Reference Example 4.

*Evaluation of Rate Capability

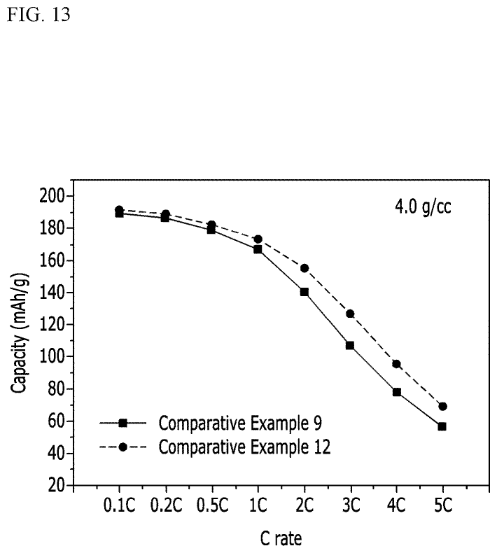

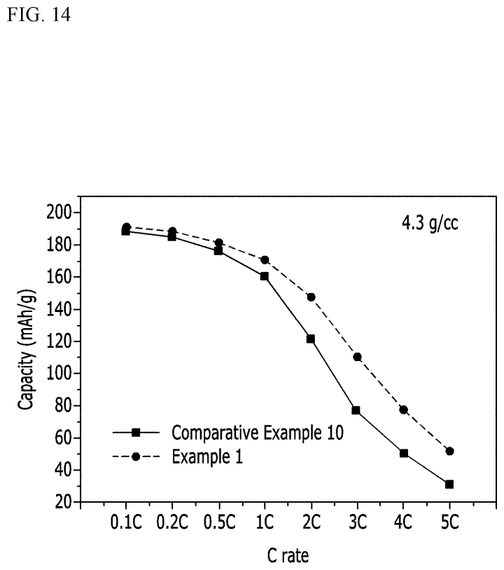

The half-cells according to Comparative Examples 8 to 12 and Example 1 were respectively once charged and discharged at each C-rate by changing the C-rate into 0.1 C, 0.2 C, 0.5 C, 1 C, 2 C, 3 C, 4 C, and 5 C, and the results are shown in FIGS. 12 to 14. FIG. 12 shows the result of Comparative Examples 8 and 11, FIG. 13 shows the result of Comparative Examples 9 and 12, and FIG. 14 shows the result of Example 1 and Comparative Example 10.

As shown in FIGS. 12 and 13, when the material mix density was low like 3.7 g/cc, Comparative Example 8 using only denka black, Comparative Example 11 using both denka black and graphene exhibited almost no effect of improving charge capacity, but when the material mix density was increased into 4.0 g/cc, Comparative Example 12 using denka black and graphene exhibited a little increased charge capacity compared with Comparative Example 9 using only denka black. In addition, when the material mix density was increased into 4.3 g/cc, the half-cell using denka black and graphene according to Example 1 exhibited greatly increased charge capacity compared with Comparative Example 10 using only denka black.

While this invention has been described in connection with what is presently considered to be practical exemplary embodiments, it is to be understood that the invention is not limited to the disclosed embodiments, and on the contrary, it is intended to cover various modifications and equivalent arrangements included within the spirit and scope of the appended claims.

1. A lithium secondary battery cathode, comprising
a current collector and
a cathode active material layer disposed on the current collector and comprising a cathode active material, a binder, graphene, and carbon black
wherein a material mix density is greater than or equal to 4.3 g/cc.

2. The lithium secondary battery cathode of claim 1, wherein an amount of the graphene is 0.01 wt % to 0.29 wt % based on 100 wt % of the cathode active material layer.

3. The lithium secondary battery cathode of claim 1, wherein an amount of the carbon black is 1 wt % to 3 wt % based on 100 wt % of the cathode active material layer.

4. The lithium secondary battery cathode of claim 1, wherein a mixing ratio of the graphene and the carbon black is a weight ratio of 1:100 to 1:3.

5. The lithium secondary battery cathode of claim 1, wherein the carbon black comprises denka black, acetylene black, ketjen black, or a combination thereof.

6. The lithium secondary battery cathode of claim 1, wherein the material mix density is 4.3 g/cc to 4.5 g/cc.

7. A lithium secondary battery comprising
a cathode of claim 1;
an anode including an anode active material; and
an electrolyte.
